(19) United States
(12) Patent Application Publication
(10) Pub. No.: US 2022/0327389 A1
(43) Pub. Date: Oct. 13, 2022

(54) Detecting and Classifying Anomalies in Artificial Intelligence Systems

(71) Applicant: Georgia Tech Research Corporation, Atlanta, GA (US)

(72) Inventors: Ghassan AlRegib, Atlanta, GA (US); Gukyeong Kwon, Atlanta, GA (US); Mohit Prabhushankar, Atlanta, GA (US); Dogancan Temel, Atlanta, GA (US)

(21) Appl. No.: 17/633,878

(22) PCT Filed: Sep. 4, 2020
(86) PCT No.: PCT/US20/49331

§ 371 Date: Feb. 8, 2022

Related U.S. Application Data
(60) Provisional application No. 62/899,783, filed on Sep. 13, 2019.
(60) Provisional application No. 62/895,556, filed on Sep. 4, 2019.

(51) Int. Cl. G06N 3/08; G06N 3/04; G06K 9/62; G06F 11/36

(52) U.S. Cl. CPC G06N 3/084; G06N 3/0454; G06K 9/6256; G06F 11/3688

(57) ABSTRACT

In a method for determining if a test data set is anomalous in a deep neural network that has been trained with a plurality of training data sets resulting in back propagated training gradients having statistical measures thereof, the test data set is forward propagated through the deep neural network so as to generate test data intended labels including at least original data, prediction labels, and segmentation maps. The test data intended labels are back propagated through the deep neural network so as to generate a test data back propagated gradient. If the test data back propagated gradient differs from one of the statistical measures of the back propagated training gradients by a predetermined amount, then an indication that the test data set is anomalous is generated. The statistical measures of the back propagated training gradient include a quantity including an average of all the back propagated training gradients.

### CROSS-REFERENCE TO RELATED APPLICATION(S)

This application claims the benefit of U.S. Provisional Patent Application Ser. No. 62/895,556, filed Sep. 4, 2019, the entirety of which is hereby incorporated herein by reference. This application also claims the benefit of U.S. Provisional Patent Application Ser. No. 62/899,783, filed Sep. 13, 2019, the entirety of which is hereby incorporated herein by reference.

### BACKGROUND OF THE INVENTION

### 1. Field of the Invention

The present invention relates to artificial intelligence systems and, more specifically, to a system for detecting and classifying anomalous data in a neural network.

### 2. Description of the Related Art

Recent advancements in deep learning enable algorithms to achieve state-of-the-art performance in diverse applications such as image classification, image segmentation, and object detection. However, the performance of such learning algorithms still suffers when abnormal data is given to the algorithms. Abnormal data encompasses data whose classes or attributes differ from training samples. Recent studies have revealed the vulnerability of deep neural networks against abnormal data. This becomes particularly problematic when trained models are deployed in critical real-world scenarios. Neural networks can make wrong predictions for anomalies with high confidence, which can lead to serious consequences.

Representation from neural networks plays a key role in anomaly detection. Such representation is expected to differentiate normal data from abnormal data clearly. To achieve sufficient separation, most of existing anomaly detection methods deploy a representation obtained in a form of activation. Activation-based representation is constrained during training. During inference, deviation of activation from the constrained representation is formulated as an anomaly score. In one example of a widely used activation-based representation from an autoencoder, assume that the autoencoder is trained with digit ‘0’ and learns to accurately reconstruct curved edges. When an abnormal image, digit ‘5’, is given to the network, the top and bottom curved edges are correctly reconstructed but the relatively complicated structure of straight edges in the middle cannot be reconstructed.

Reconstruction error measures the difference between the target and the reconstructed image and it can be used to detect anomalies. The reconstructed image, which is the activation-based representation from the autoencoder, characterizes what the network knows about input. Thus, abnormality is characterized by measuring how much of the input does not correspond to the learned information of the network.

Most existing anomaly detection algorithms focus on learning constrained activation-based representations during training. Several systems directly learn hyperplanes or hyperspheres in hidden representation space to detect anomalies. One-Class support vector machine learns a maximum margin hyperplane that separates data from the origin in the feature space. Abnormal data is expected to lie on the other side of normal data and separated by the hyperplane. One method learns a smallest hypersphere that encloses the most of training data in the feature space. A deep neural network is trained to constrain the activation-based representations of data into the minimum volume of hypersphere. For any given test sample, an anomaly score is defined by the distance between the sample and the center of hypersphere.

An autoencoder has been a dominant learning framework for anomaly detection. The autoencoder generates two well-constrained representations, which include latent representation and reconstructed image representations. Based on these constrained representations, latent loss or reconstruction error have been widely used as anomaly scores. Some have suggested that anomalies cannot be accurately projected in the latent space and are poorly reconstructed. Therefore, they use the reconstruction error to detect anomalies.

Certain systems use Gaussian mixture models (GMM) to reconstruction error features and latent variables and estimate the likelihood of inputs to detect anomalies. One employs an autoregressive density estimation model to learn the probability distribution of the latent representation. The likelihood of the latent representation and the reconstruction error are used to detect abnormal data.

Adversarial training has also been used to differentiate the representation of abnormal data. In general, a generator learns to generate realistic data similar to training data and a discriminator is trained to discriminate whether the data is generated from the generator (fake) or from training data (real). The discriminator learns a decision boundary around training data and is utilized as an abnormality detector during testing. One system attempts to adversarilally train a discriminator with an autoencoder to classify reconstructed images from original images and distorted images. The discriminator is utilized as an anomaly detector during testing. Mapping from a query image to a latent variable in a generative adversarial network is estimated. The loss, which measures visual similarity and feature matching for the mapping, is utilized as an anomaly score. An adversarial autoencoder can be used to learn the parameterized manifold in the latent space and estimate probability distributions for anomaly detection.

Many existing systems exclusively focus on distinguishing between normal and abnormal data in the activation-based representations. In particular, most systems use adversarial networks or likelihood estimation networks to further constrain activation-based representations. These networks often require a large amount of training parameters and computations.

Backpropagated gradients have been utilized in diverse applications. Backpropagated gradients have been widely used for visualization of deep networks, in which information that networks have learned for a specific target class is mapped back to the pixel space through backpropagation and is then visualized. Gradients have been used with respect to the activation to weight the activation and visualize the reasoning for prediction that neural networks have made. Visualizing an adversarial attack is another application of gradients. Adversarial attacks can be generated by adding an imperceptibly small vector which is the signum of input gradients. Several systems incorporate gradients with respect to the input in a form of regularization during the training of neural networks to improve the robustness. Although existing works have shown that gradients with respect to the input or the activation can be useful for diverse applications, gradients with respect to the weights of neural networks have not been actively explored aside from its role in training deep networks.

Gradients with respect to the model parameters as features for data have been studied. One system proposes the use of Fisher kernels that are based on the normalized gradient vectors of the generative model for image categorization. Information encoded in the neural network and Fisher information can be characterized to be used to represent tasks. Gradients have been also studied as a local liner approximation to a neural network.

Therefore, there is a need for an anomaly detection system using gradient-based representations that outperforms existing activation-based representation systems.

### SUMMARY OF THE INVENTION

The disadvantages of the prior art are overcome by the present invention which, in one aspect, is a method for determining if a test data set is anomalous in a deep neural network that has been trained with a plurality of training data sets resulting in back propagated training gradients having statistical measures thereof. The test data set is forward propagated through the deep neural network so as to generate test data intended labels including at least original data, prediction labels, and segmentation maps. The test data intended labels are back propagated through the deep neural network so as to generate a test data back propagated gradient. If the test data back propagated gradient differs from one of the statistical measures of the back propagated training gradients by a predetermined amount, then an indication that the test data set is anomalous is generated. The statistical measures of the back propagated training gradient include a quantity including an average of all the back propagated training gradients.

In another aspect, the invention is a method for indicating that test data set is anomalous in a deep neural network that has been trained with a plurality of training data sets resulting in back propagated training gradients having statistical measures thereof. The test data set is propagated through the deep neural network so as to generate test data intended labels including at least original data, prediction labels, and segmentation maps. The test data intended labels are back propagated through the deep neural network so as to generate a test data back propagated gradient. If the test data back propagated gradient differs from one of the statistical measures of the back propagated training gradients by a predetermined amount, then an indication that the test data set is anomalous is generated. The statistical measures of the back propagated training gradient include a quantity including an average of all the back propagated training gradients, and the deep neural network is modeled by a manifold in which statistical measures of the back propagated test data set gradient include one or more directional components that points away from the manifold.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1A is a schematic diagram demonstrating activation and gradient-based representation for anomaly detection.

FIG. 1B is a schematic diagram demonstrating activation and gradient-based representation for anomaly detection.

FIG. 2 is a of photographs demonstrating different types of image distortion.

FIGS. 3A-3B are schematic diagrams presenting geometric interpretation of gradients.

FIG. 4 is a schematic diagram showing a gradient constraint on the manifold.

### DETAILED DESCRIPTION OF THE INVENTION

A preferred embodiment of the invention is now described in detail. Referring to the drawings, like numbers indicate like parts throughout the views. Unless otherwise specifically indicated in the disclosure that follows, the drawings are not necessarily drawn to scale. The present disclosure should in no way be limited to the exemplary implementations and techniques illustrated in the drawings and described below. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

The present invention generalizes the Fisher kernel principal using the backpropagated gradients from the neural networks. Since the system uses the backpropagated gradients to estimate the Fisher score of normal data distribution, the data does not need to be modeled by known probabilistic distributions such as a GMM. It also uses the gradients to represent information that the networks have not learned. In particular, the system provides its interpretation of gradients which characterize abnormal information for the neural networks and validate their effectiveness in anomaly detection.

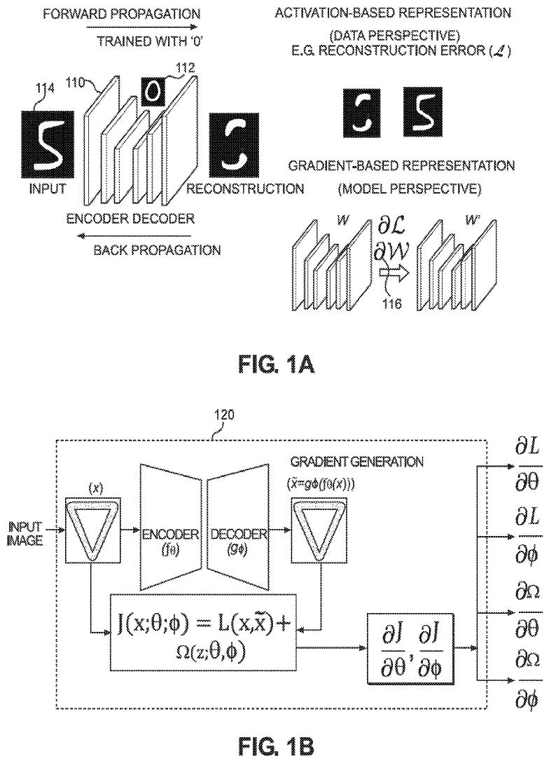

The present invention employs gradient-based representations to detect anomalies by characterizing model updates caused by data. Gradients are generated through backpropagation to train neural networks by minimizing designed loss functions. During training, the gradients with respect to the weights provide directional information to update the neural network and learn knowledge that it has not learned. The gradients from normal data do not guide a significant change of the current weight. However, the gradients from abnormal data guide more drastic updates on the network to fully represent data. While activation characterizes how much of input correspond to learned information, gradients focus on model updates required by the input necessary to learn a new input. In an example demonstrated in FIG. 1A, the network 100 has been trained with the digit ‘0’ 112, but not the digit ‘5’. The autoencoder needs larger updates to accurately reconstruct the abnormal image, which in this example is the digit ‘5’ 114, than the normal image, digit ‘0’ 112. The gradients 116 indicate the magnitude of the updates that would be necessary to reconstruct the test image (i.e., the digit ‘5’). Therefore, the gradients 116 can be utilized as representations to characterize abnormality of data. One can detect anomalies by measuring how much model update is required by the input compared to normal data.

A deep neural network can be modeled by a manifold in which statistical measures of the back propagated test data set gradient have at least one directional component that points away from the manifold. In doing so, the system can approximate a probability of the test data set being anomalous as a function of directional divergence between the first directional component of the averaged back propagated training gradient and the second directional component of the test data back propagating gradient. The first test data back propagating gradient indicates an amount of model update that would be required to retrain the deep neural network to learn the test data set. In fact, the system can also use gradients to indicate a measure of vulnerability of the deep neural network.

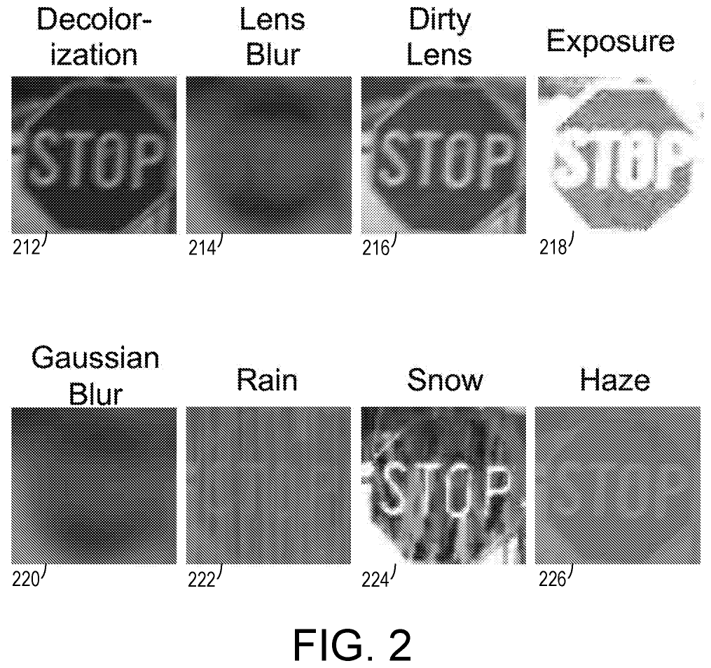

Typically, the training data and the test data set will consist of image data, which can include such image data as: photographic data, video data, point cloud data, and multidimensional data. Image data sometimes includes distortions. As shown in FIG. 2, such image distortions can include images with: decolorization 212, lens blur 214, dirty lens 216, improper exposure 218, gaussian blur 220, rain 222, snow 224, haze 226 and other combinations of these distortions. One embodiment detects these types of distortions and indicates that these are anomalous data. In fact, when distorted images such as these are detected by the system, they can be used to retrain the deep neural network so at to be able to recognize such distorted images in the future.

In one embodiment, an anomalous data indication is generated when the test data set is of a class of data set with which the deep neural network was not trained. For example, if the neural network is trained with images of animals and an image of a sailboat is used as test data, the system will generate an anomalous data indication that improper data was input into the system. Also, in one embodiment, the system can generate an anomalous data indicator when the test data set includes malicious data. Certain types of malicious data can have back propagated gradients with characteristic gradients. When such characteristic gradients are detected, the system can alert a user that malicious data is present when the first test data back propagating gradient has a value that indicates a probability that the test data set includes malicious data is above a defined threshold.

Gradient-based representations have several advantages compared to activation-based representations, particularly for anomaly detection. First, gradient-based representations provide abnormality characterization at different levels of data abstraction. The deviation of the activation-based representations from the constraint, often formulated as a loss ( [symbol] ), is measured from the output of specific layers. On the other hand, the gradients with respect to the weights (∂ [symbol] /∂W) can be obtained from any layer through backpropagation. This enables the system to capture fine-grained abnormality both in low-level characteristics such as edge or color and high-level class semantics. In addition, the gradient-based representations provide directional information to characterize anomalies. The loss in the activation-based representation often measures the distance between representations of normal and abnormal data. However, by utilizing a loss defined in the gradient-based representations, the system can use vectors to analyze direction in which the representation of abnormal data deviates from that of normal data. Considering that the gradients are obtained in parallel with the activation, the directional information of the gradients provides complementary features for anomaly detection along with the activation. Thus, the system employs backpropagated gradients as representations to characterize anomalies.

Intuitively, gradients can be viewed from a geometric and a theoretical perspective. Geometric interpretation of gradients highlights the advantages of the gradients over activation from a data manifold perspective. Also, theory of information geometry further supports the characterization of anomalies using the gradients.

An autoencoder, which is an unsupervised representation learning framework, can be used to explain the geometric interpretation of gradients. An autoencoder typically includes an encoder, f_{θ}, and a decoder, g_{φ}. From an input data set (such as a set of image data), x, a latent variable, z, is generated as z=f_{θ}(x) and a reconstructed image is obtained by feeding the latent variable into the decoder, g_{φ}(f_{θ}(x)). The training is performed by minimizing a loss function, J(x; θ, φ), defined as follows:

J(x;θ,φ)= [symbol] (x,g_{φ},(f_{θ}(x)))+Ω(z;θ,φ),

where [symbol] is a reconstruction error, which measures the dissimilarity between the input and the reconstructed image and Ω is a regularization term for the latent variable.

One method of generating the gradients 120 is demonstrated in FIG. 1B. In this method, a test images passed through a trained network as the input. The feedforward loss (shown in the equation above) is calculated. The loss is the sum of the reconstruction loss, [symbol] , and the regularization loss, Ω. In the loss function, the reconstruction error and the regularization serve different roles during optimization. Therefore, gradients backpropagated from both terms characterize different aspects of distortions in a test image.

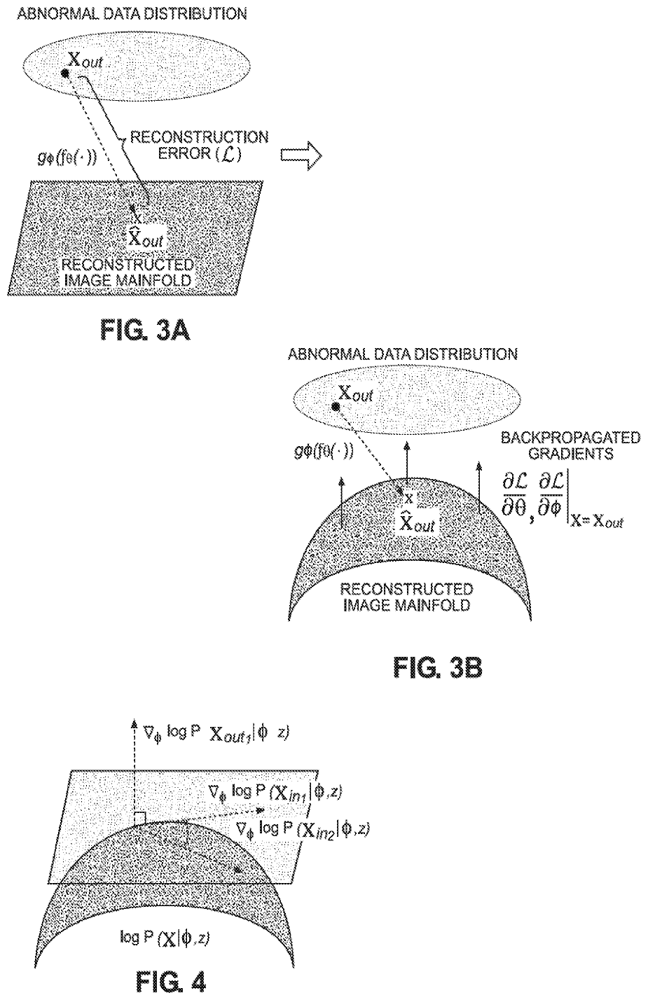

The geometric interpretation of backpropagated gradients is visualized in FIGS. 2A-2B. The autoencoder is trained to accurately reconstruct training images and the reconstructed training images form a manifold. For simplicity of explanation, this assumes that the structure of the manifold is a linear plane as shown in the figure. During testing, any given input to the autoencoder is projected onto the reconstructed image manifold through the projection, g_{φ}(f_{θ}(xₒᵤₜ)). Ideally, perfect reconstruction is achieved when the reconstructed image manifold includes the input image. Assume that abnormal data distribution is outside of the reconstructed image manifold. When an abnormal image, xₒᵤₜ, sampled from the distribution is input to the autoencoder, it will be reconstructed as \hat{x}ₒᵤₜ through the projection, g_{φ}(f_{θ}(xₒᵤₜ)). Since the abnormal image has not been utilized for training, it will be poorly reconstructed. The distance between xₒᵤₜ and \hat{x}ₒᵤₜ is formulated as the reconstruction error and characterizes the abnormality of the data as shown in FIG. 3A. The gradients with respect to the weights,

$$\frac{\partial ℒ}{\partial θ} , \frac{\partial ℒ}{\partial ϕ} ,$$

can be calculated through the backpropagation of the reconstruction error. These gradients represent required changes in the reconstructed image manifold to incorporate the abnormal image and reconstruct it accurately as shown in FIG. 3B. In other words, these gradients characterize orthogonal variations of the abnormal data distribution with respect to the reconstructed image manifold.

The interpretation of gradients from the data manifold perspective highlights the advantages of gradients in anomaly detection. In activation-based representations, the abnormality is characterized by distance information measured using a designed loss function. Additionally, the gradients provide directional information, which indicates the movement of manifold in which data representations reside. This movement characterizes, in particular, in which direction the abnormal data distribution deviates from the representations of normal data. Furthermore, the gradients obtained from different layers provide a comprehensive perspective to represent anomalies with respect to the current representations of normal data. Therefore, the directional information from gradients can be utilized as complementary information to the distance information from the activation.

Theoretical Interpretation of Gradients: Theoretical explanation for gradient-based representations can be derived from information geometry, particularly using the Fisher kernel. Based on the Fisher kernel, it can be shown that the gradient-based representations characterize model updates from query data and differentiate normal from abnormal data. One embodiment utilizes the same setup of an autoencoder described above, but considers the encoder and the decoder as probability distributions. Given the latent variable, z, the decoder models input distribution through a conditional distribution, P_{φ}(x|z). The autoencoder is trained to minimize the negative log-likelihood, −log P_{φ})(x|z). When x is a real value and P_{φ},(x|z) is assumed to be a Gaussian distribution, the decoder estimates the mean of the Gaussian. Also, the minimization of the negative log-likelihood corresponds to using a mean squared error as the reconstruction error. When x is a binary value, the decoder is assumed to be a Bernoulli distribution. The negative log-likelihood is formulated as a binary cross entropy loss. Considering the decoder as the conditional probability enables us to interpret gradients using the Fisher kernel.

The Fisher kernel defines a metric between samples using the gradients of generative probability distribution. Let X be a set of samples and P(X|θ) is a probability density function of the samples parameterized by θ=[θ1, θ2, . . . , θN]^{T}∈R^{N}. This probability distribution models a Riemannian manifold with a local metric defined by Fisher information matrix, F∈R^{N×N}, as follows:

$$F = {𝔼}_{x ∈ X} [ {U}_{θ}^{X} {U}_{θ}^{{X}^{T}} ] where {U}_{θ}^{X} = {∇}_{θ} log P ( X \vert θ ) .$$

U_{θ}^{X} is called the Fisher score which describes the contribution of the parameters in modeling the data distribution. The Fisher kernel can be used to measure the difference between two samples based on the Fisher score. The Fisher kernel, K_{FX}, is defined as:

K_{FK}(Xᵢ,Xⱼ)=U_{θ}^{X}^{ᵢ}^{^{T}}F⁻¹U_{θ}^{X}^{ⱼ},

where Xᵢ and Xⱼ are two data samples. The Fisher kernels enable to extract discriminant features from the generative model and they have been actively used in diverse applications such as image categorization, image classification, and action recognition.

The system uses the Fisher kernel estimated from the autoencoder for anomaly detection. The distribution of the decoder is parameterized by the weights, φ, and the Fisher score from the decoder is defined as:

U_{ϕ,z}^{X}=∇_{ϕ}log P(X|ϕ,z).

Also, since the distribution is learned to be generalizable to the test data, one embodiment can use the Fisher kernel to measure the distance between training data and normal test data, and between training data and abnormal test data. The Fisher kernel for normal data (inliers), Kⁱⁿ_{FK} and abnormal data (outliers), K^{out}_{FK}, are derived as follows, respectively:

K_{FK}ⁱⁿ(Xₜᵣ,T_{te,in})=U_{ϕ}^{X}^{ₜᵣ}^{^{T}}F⁻¹U_{ϕ,z}X^{te,in}

K_{FK}^{out}(Xₜᵣ,X_{te,out})=U_{ϕ}^{X}^{ₜᵣ}^{^{T}}F⁻¹U_{ϕ,z}^{X}^{_{te,out}},

where Xₜᵣ, X_{te,in}, X_{te,out} are training data, normal test data, and abnormal test data, respectively. For ideal anomaly detection, K^{out}_{FK} should be larger than Kⁱⁿ_{FK} to clearly differentiate normal and abnormal data. The difference between Kⁱⁿ_{FK} and K^{out}_{FK} is characterized by the Fisher scores U_{ϕ,z}^{X}^{_{te,in}} and U_{ϕ,z}^{X}^{_{te,out}}. Therefore, the Fisher scores from query data are discriminant features for detecting anomalies. The system estimates the Fisher scores using the backpropagated gradients with respect to the weights of the decoder. Since the autoencoder is trained to minimize the negative log-likelihood loss, [symbol] =−log P_{ϕ}(x|z), the backpropagated gradients,

$$\frac{\partial ℒ}{\partial ϕ} ,$$

obtained from normal and abnormal data estimate U_{ϕ,z}^{X}^{_{te,in}} and U_{ϕ,z}^{X}^{_{te,out}} when the autoencoder is trained with a sufficiently large amount of data to model the data distribution. Therefore, one can interpret the gradient-based representations as discriminant representations obtained from the conditional probabilistic modeling of data for anomaly detection.

The system visualizes the gradients with respect to the weights of the decoder obtained by backpropagating the reconstruction error, [symbol] , from normal data, x_{in,1}, x_{in,2}, and abnormal data, x_{out,1}, as shown in FIG. 4. These gradients estimate the Fisher scores for inliers and outliers, which need to be clearly separated for anomaly detection. Given the definition of the Fisher scores, the gradients from normal data tend to contribute less to the change of the manifold compared to those from abnormal data. Therefore, the gradients from normal data tend to reside in the tangent space of the manifold but abnormal data results in the gradients orthogonal to the tangent space. This separation is achieved in gradient-based representations through directional constraint as described in more detail below.

The separation between inliers and outliers in the representation space is often achieved by modeling the normality of data. The deviation from the normality model captures the abnormality. The normality is often modeled through constraints imposed during training. The constraint allows normal data to be easily constrained but makes abnormal data deviate. For example, the autoencoders constrain the output to be similar to the input and the reconstruction error measures the deviation. A variational autoencoder (VAE) and an adversarial autoencoder (AAE) often constrain the latent representation to follow the Gaussian distribution and the deviation from the Gaussian distribution characterizes anomalies. In the gradient-based representations, the system also imposes a constraint during training to model the normality of data and further differentiate U_{ϕ,z}^{X}^{_{te,in}} from U_{ϕ,z}^{X}^{_{te,out}}, as defined above.

The system trains an autoencoder with a directional gradient constraint to model the normality. In particular, based on the interpretation of gradients from the Fisher kernel perspective, it enforces the alignment between gradients. This constraint makes the gradients from normal data aligned with each other and results in small changes to the manifold. On the other hand, the gradients from abnormal data will not be aligned with others and guide abrupt changes to the manifold. The system utilizes a gradient loss, [symbol] _{grad}, as a regularization term in the entire loss function, J. It calculates the cosine similarity between the gradients of a certain layer i in the decoder at the k^{th} iteration of training,

$${\frac{\partial ℒ}{\partial {ϕ}_{i}}}^{k}$$

and the average of the training gradients of the same layer i obtained until the (k−1)^{th} iteration,

$${\frac{\partial 𝒥}{\partial {ϕ}_{i}}}_{avg}^{k - 1}$$

The gradient loss at the k^{th} iteration of training is obtained by averaging the cosine similarity over all the lavers in the decoder as follows:

$${ℒ}_{grad} = - {𝔼}_{i} [ cos SIM ( {\frac{\partial 𝒥}{\partial {ϕ}_{i}}}_{avg}^{k - 1} , {\frac{\partial ℒ}{\partial {ϕ}_{i}}}^{k} ) ] , {\frac{\partial 𝒥}{\partial {ϕ}_{i}}}_{avg}^{k - 1} = \frac{1}{( k - 1 )} {\sum }_{i = 1}^{k - 1} {\frac{\partial 𝒥}{\partial {ϕ}_{i}}}^{t} ,$$

where J is defined as J= [symbol] +Ω+α [symbol] _{grad}. The first and the second terms are the reconstruction error and the latent loss, respectively and they are defined by different types of autoencoders. α is a weight for the gradient loss. The system sets sufficiently small α value to ensure that gradients actively explore the optimal weights until the reconstruction error and the latent loss become small enough. Based on the interpretation of the gradients described above, the system only constrains the gradients of the decoder layers and the encoder layers remain unconstrained.

During training, [symbol] is first calculated from the forward propagation. Through the backpropagation,

$${\frac{\partial ℒ}{\partial {ϕ}_{i}}}^{k}$$

is obtained without updating the weights. Based on the obtained gradient, the entire loss J is calculated and finally the weights are updated using backpropagated gradients from the loss J. An anomaly score is defined by the combination of the reconstruction error and the gradient loss as [symbol] +β [symbol] _{grad}. Although the system uses a to weight the gradient loss during training, it was found that the gradient loss is often more effective than the reconstruction error for anomaly detection. To better balance the two losses, one embodiment uses β=4α for all the experiments and show that the weighted combination of two losses improve the performance.

The average of the gradients is used repeatedly. The system can generalize to any statistical measure of the gradients and not only averaged gradients. While image data is used in the disclosure above, the system can be applied to other types of data beyond image data. Examples of such data include audio data, speech data and many other types of data.

Although specific advantages have been enumerated above, various embodiments may include some, none, or all of the enumerated advantages. Other technical advantages may become readily apparent to one of ordinary skill in the art after review of the following figures and description. It is understood that, although exemplary embodiments are illustrated in the figures and described below, the principles of the present disclosure may be implemented using any number of techniques, whether currently known or not. Modifications, additions, or omissions may be made to the systems, apparatuses, and methods described herein without departing from the scope of the invention. The components of the systems and apparatuses may be integrated or separated. The operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. It is intended that the claims and claim elements recited below do not invoke 35 U.S.C. § 112(f) unless the words “means for” or “step for” are explicitly used in the particular claim. The above described embodiments, while including the preferred embodiment and the best mode of the invention known to the inventor at the time of filing, are given as illustrative examples only. It will be readily appreciated that many deviations may be made from the specific embodiments disclosed in this specification without departing from the spirit and scope of the invention. Accordingly, the scope of the invention is to be determined by the claims below rather than being limited to the specifically described embodiments above.

What is claimed is:

1. A method for determining if a test data set is anomalous in a deep neural network that has been trained with a plurality of training data sets resulting in back propagated training gradients having statistical measures thereof, comprising the steps of:
(a) forward propagating the test data set through the deep neural network so as to generate test data intended labels including at least original data, prediction labels, and segmentation maps;
(b) back propagating the test data intended labels through the deep neural network so as to generate a test data back propagated gradient; and
(c) if the test data back propagated gradient differs from one of the statistical measures of the back propagated training gradients by a predetermined amount, then generating an indication that the test data set is anomalous, wherein the statistical measures of the back propagated training gradient include a quantity including an average of all the back propagated training gradients.

2. The method of claim 1, wherein the deep neural network is modeled by a manifold in which statistical measures of the back propagated test data set gradient have at least one directional component that points away from the manifold.

3. The method of claim 2, further comprising the step of approximating a probability of the test data set being anomalous as a function of directional divergence between the first directional component of the averaged back propagated training gradient and the second directional component of the test data back propagating gradient.

4. The method of claim 3, wherein the first test data back propagating gradient indicates an amount of model update that would be required to retrain the deep neural network to learn the test data set.

5. The method of claim 3, further comprising the step of indicating a measure of vulnerability of the deep neural network.

6. The method of claim 1, wherein the test data set comprises image data and wherein each of plurality of training data sets comprise image data.

7. The method of claim 6, wherein the image data comprises data selected from a list of image data types consisting of: photographic data, video data, point cloud data, and multidimensional data.

8. The method of claim 6, further comprising the step of indicating that the test data set is anomalous when the image data has a distortion.

9. The method of claim 8, wherein the distortion includes a state of the image data selected from a list of states consisting of: decolorization, lens blur, dirty lens, improper exposure, gaussian blur, rain, snow, haze and combinations thereof.

10. The method of claim 1, further comprising the step of indicating that the test data set is anomalous when the test data set is of a class of data set with which the deep neural network was not trained.

11. The method of claim 1, further comprising the step of indicating that the test data set is anomalous when the test data set includes malicious data.

12. The method of claim 11, further comprising the step of alerting a user that malicious data is present when the first test data back propagating gradient has a value that indicates a probability that the test data set includes malicious data is above a defined threshold.

13. A method for indicating that test data set is anomalous in a deep neural network that has been trained with a plurality of training data sets resulting in back propagated training gradients having statistical measures thereof, comprising the steps of:
(a) forward propagating the test data set through the deep neural network so as to generate test data intended labels including at least original data, prediction labels, and segmentation maps;
(b) back propagating the test data intended labels through the deep neural network so as to generate a test data back propagated gradient; and
(c) if the test data back propagated gradient differs from one of the statistical measures of the back propagated training gradients by a predetermined amount, then generating an indication that the test data set is anomalous, wherein the statistical measures of the back propagated training gradient includes a quantity including an average of all the back propagated training gradients, and wherein the deep neural network is modeled by a manifold in which statistical measures of the back propagated test data set gradient include at least one directional component that points away from the manifold.

14. The method of claim 13, further comprising the step of approximating a probability of the test data set being anomalous as a function of directional divergence between the first directional component of the averaged back propagated training gradient and the second directional component of the test data back propagating gradient.

15. The method of claim 14, wherein the first test data back propagating gradient indicates an amount of model update that would be required to retrain the deep neural network to learn the test data set.

16. The method of claim 14, further comprising the step of indicating a measure of vulnerability of the deep neural network.

17. The method of claim 13, wherein the test data set comprises image data and wherein each of plurality of training data sets comprise image data, wherein the image data comprises data selected from a list of image data types consisting of: photographic data, video data, point cloud data, and multidimensional data.

18. The method of claim 17, further comprising the step of indicating that the test data set is anomalous when the image data has a distortion, wherein the distortion includes a state of the image data selected from a list of states consisting of: decolorization, lens blur, dirty lens, improper exposure, gaussian blur, rain, snow, haze and combinations thereof.

19. The method of claim 13, further comprising the step of indicating that the test data set is anomalous when the test data set is of a class of data set with which the deep neural network was not trained.

20. The method of claim 13, further comprising the step of indicating that the test data set is anomalous when the test data set includes malicious data and alerting a user that malicious data is present the first test data back propagating gradient has a value that indicates a probability that the test data set includes malicious data is above a defined threshold.
